(19) United States
(12) Patent Application Publication
(10) Pub. No.: US 2012/0137894 A1
(43) Pub. Date: Jun. 7, 2012

(54) DEVICE FOR STORING MILK

(75) Inventor: Frank Goeltenboth, Blaustein (DE)

(73) Assignee: WMF WUERTTEMBERGISCHE METALLWARENFABRIK AG, Geislingen/Steige (DE)

(21) Appl. No.: 13/388,680

(22) PCT Filed: Jul. 21, 2010
(86) PCT No.: PCT/EP10/60547

§ 371 Date: Feb. 3, 2012

(30) Foreign Application Priority Data
Aug. 4, 2009 (DE) 10 2009 036 089.1

(51) Int. Cl. F28F 27/00; A47J 31/44; B65D 85/00; B65D 25/00

(52) U.S. Cl. 99/285; 220/694; 165/11.1; 206/459.1

(57) ABSTRACT

The invention relates to a device (1) for storing milk (2), particularly for further use in a coffee machine (3) comprising a container (4) accommodating the milk (2). It is essential to the invention that a temperature sensing device (5) comprising at least one infrared sensor (6, 6′, 6″) is provided for sensing the temperature of the milk.

### BACKGROUND OF THE INVENTION

1. Field of the Invention

The instant invention relates to a device for storing milk, in particular for further use in a coffee machine, according to the preamble of claim 1. The invention furthermore relates to a coffee machine comprising such a device.

2. Description of the Related Art

Today, coffee machines typically have a device for heating and frothing milk, with the help of which blended coffee beverages, such as cappuccino, for example, can be made. The milk, which is required for this, can thereby either be stored non-cooled in a sales package (Tetra Pack), for example, or in any container or also cooled in a small side refrigerator. Such side refrigerators sense the temperature outside of a cooling chamber indirectly, for example by means of a thermo-mechanical capillary tube regulator as thermostat or with an electronic thermostat comprising an NTC sensor, which does not only regulate the cooling, but in some cases even furthermore transmits the measured temperature to a digital display.

However, a problem of such side refrigerators is that the regulation of the temperature takes place indirectly, for example via the capillary tube regulator, so that the air temperature within the cooling chamber experiences a very high hysteresis. Even in the case of electronically operating thermostats, it is thereby impossible, due to the very indirect measuring method, to draw conclusions from the sensed temperature to the milk temperature in a milk storage container. However, in the event that the method using NTC sensors is used directly in the container, the following disadvantages result: On the one hand, the temperature sensor, which extends into the storage container, must be sealed well and permanently against the container wall, because it is to be capable of being cleaned together with the container. The electric contacts of the NTC sensor must furthermore be removable, for example so as to be able to clean the milk container, wherein such contacts can corrode and/or contaminate and can thus cause errors. A sensor, which electrically contacts the cooler in a fixed manner, which is flexibly suspended so that it can be dipped into the milk, is also possible, but can hardly be kept hygienically clean. A further problem in the case of currently known solutions is that a dispensing temperature of the milk froth or of the milk, respectively, at a corresponding coffee machine depends on the storage temperature thereof, which, as a rule, is not known or which is hypothetically assumed as being cooled. However, fluctuations of the storage temperature of the milk thereby do not only lead to fluctuations of the dispensing temperature, but in the case of Venturi systems, for example, they also lead to quantity fluctuations and thus always to fluctuations of the milk froth quality as well.

The instant invention thus deals with the problem of sensing a temperature of stored milk as accurately and error-free as possible and to thus improve a milk froth quality at a coffee machine.

### SUMMARY OF THE INVENTION

The instant invention is based on the general idea of providing a temperature sensing device comprising at least one infrared sensor, by means of which the milk temperature can be sensed accurately, in a device for storing milk, in particular for further use in a coffee machine. The accurate sensing of the milk temperature can furthermore be used as basis for the control/regulation of the milk froth production in an adjacent coffee machine, so that the accurate sensing of the temperature of the stored milk has a positive impact on the quality of the milk froth, which is to be produced. It is not only possible to accurately sense the temperature of the stored milk by means of the infrared sensor according to the invention, but it can furthermore also be sensed in a contactless manner, so that the at least one infrared sensor can be arranged in the device at a location of the container, which accommodates the milk, which is typically not in direct contact with the milk and which is thus exposed to considerably fewer contaminations. Generally, the invention thus uses the principle of infrared thermography so as to determine the temperature of the milk and to thus be able to have a positive influence on a subsequent processing operation, for example in a milk frother of a coffee machine.

In the case of an advantageous further development of the solution according to the invention, the device encompasses a cooling device for cooling the milk, which is regulated by a regulating device, which receives signals from the temperature sensing device. The adjusting of a preferably constant milk temperature is thus possible by means of the temperature sensing device and the cooling device, which also leads to a high quality of milk froth, which is to later be produced from this milk. A simple control cycle, which can be realized in a cost-efficient manner on the one hand and, on the other hand, which effects a constant milk temperature and thus a high quality of the milk froth, which is to be dispensed, can be created by means of the regulating device, which receives its input signals from the temperature sensing device and which controls or regulates, respectively, the cooling device as a function of these received signals.

Advantageously, provision is made for a display device, which displays, that is, visualizes, the milk temperature sensed by the temperature sensing device. For example, such a display device can display the milk temperature digitally or also by means of a corresponding indicator and thus always informs the user of the device about the currently prevailing milk temperature. Such a display device for visualizing the milk temperature thereby represents an additional feature, which is often perceived by the customers as a special comfort.

Further important features and advantages of the invention follow from the subclaims, from the drawing and from the corresponding figure description by means of the drawings.

It goes without saying that the features mentioned above and the features, which will still be defined below, cannot only be used in the respectively specified combination, but also in other combinations or alone, without leaving the context of the instant invention.

A preferred exemplary embodiment of the invention is illustrated in the drawing and will be defined in more detail in the following description.

### BRIEF DESCRIPTION OF THE DRAWINGS

FIG. 1 shows a device according to the invention in combination with a coffee machine.

### DETAILED DESCRIPTION OF THE PREFERRED EMBODIMENTS

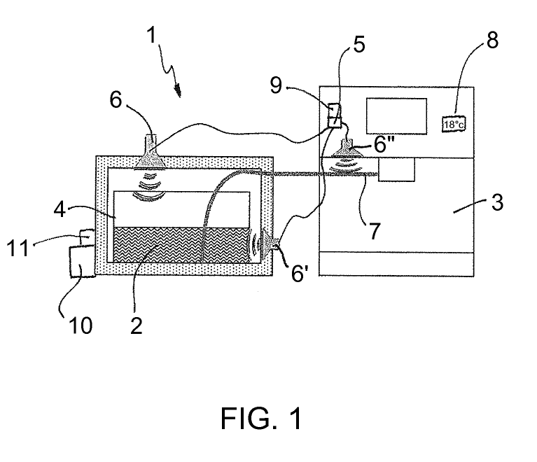

According to FIG. 1, a device 1 for storing milk 2, in particular for further use in a coffee machine 3, encompasses a container 4, which accommodates the milk 2. According to the invention, provision is furthermore made for a temperature sensing device 5 comprising at least one infrared sensor 6. According to FIG. 1, the temperature sensing device 5 is thereby arranged in the area of the coffee machine 3, whereby it goes without saying that said temperature sensing device 5 can also be arranged in the area of the device 1, that is, in particular in the area of the container 4. According to FIG. 1, a total of three infrared sensors 6, 6′, 6″ are illustrated, by means of which the temperature of the milk 2 cannot only be sensed extremely accurately, but additionally also in a contactless manner, wherein the infrared sensors 6, 6′, 6″ can in particular be arranged in areas of the device 1, which do not have any contact with the milk 2 and which are thus less likely to be contaminated.

In addition, the device 1 can encompass a cooling device 10 for cooling the milk, which is regulated by a regulating device 11, which receives input signals from the temperature sensing device 5. In this manner, a closed control cycle could be created for maintaining the temperature of the milk 2 and the milk could thus be maintained at a constant temperature level. When further considering FIG. 1, it can be seen that the infrared sensor 6′ is directed onto a surface of the container 4, wherein it is of course also possible for such an infrared sensor 6 to be directed directly onto the surface of the milk 2 or also onto a connecting line 7 to the coffee machine 3.

In the event that such an infrared sensor 6 is directed directly onto the surface of the milk 2 or onto a connecting line 7, the container 4 can be designed so as to be insulated, so that the desired milk temperature can be maintained as long as possible. Provision can furthermore be made for a display device 8, which displays the milk temperature sensed by the temperature sensing device 5 and which outputs it visually, in particular. For example, such a display device can encompass a digital display and can be a component of the coffee machine 3 or of the device 1, respectively. It is furthermore possible that a fill level of the milk 2 can be sensed in the container 4 by means of the at least one infrared sensor 6, 6′.

It is also possible that the temperature sensing device 5 is connected so as to communicate with a control device 9 of the coffee machine 3 and transmits signals to this control device 9, by means of which it controls a beverage dispensing process. In response to a deviation of an actual temperature from a nominal temperature, the control device 9 can thus stop a dispensing process, for example, or can regulate other parameters, such as, for example, a steam temperature, for the purpose of compensating storage temperature fluctuations accordingly.

A milk temperature, which can be determined accurately and which is constant, in particular, can thus be obtained by means of the device 1 according to the invention, which is particularly advantageous for producing milk froth of a high and in particular of a consistently high quality. A combination of the infrared sensors 6, 6′, 6″ can furthermore be avoided by means of the contactless temperature measurement, whereby said infrared sensors should be more durable and less susceptible to interferences. In general, the temperature sensing device 5 according to the invention can be a component of the device 1 or also a component of the coffee machine 3, provided that the device 1 in turn is a component of the coffee machine 3.

1. A device (1) for storing milk (2) for further use in a coffee machine (3), comprising: a container (4) that accommodates the milk (2), and a temperature sensing device (5) comprising at least one infrared sensor (6, 6′, 6″) for sensing temperature of the milk.

2. The device according to claim 1, further comprising a cooling device (10) for cooling the milk (2), the cooling device being regulated by a regulating device (11) that receives signals from the temperature sensing device (5).

3. The device according to claim 2, characterized in that the at least one infrared sensor (6′) is directed onto a surface of the container (4).

4. The device according to claim 2, characterized in that the at least one infrared sensor (6) is directed directly onto the milk surface.

5. The device according to claim 2, characterized in that the at least one infrared sensor (6″) is directed onto a connecting line (7) to a coffee machine (3).

6. The device according to claim 2, characterized in that the container (4) is insulated.

7. The device according to claim 2, further comprising a display device (8) that displays the milk temperature sensed by the temperature sensing device (5).

8. The device according to claims 2, characterized in that a fill level in the container (4) can be sensed the at least one infrared sensor (6, 6′).

9. A coffee machine (3) comprising a device (1) according to claim 2, characterized in that the temperature sensing device is connected to communicate with a control device (9) of the coffee machine (3) and transmits signals to the control device (9), for controlling a beverage dispensing process.

10. The device according to claim 1, characterized in that the at least one infrared sensor (6′) is directed onto a surface of the container (4).

11. The device according to claim 1, characterized in that the at least one infrared sensor (6) is directed directly onto the milk surface.

12. The device according to claim 1, characterized in that the at least one infrared sensor (6″) is directed onto a connecting line (7) to a coffee machine (3).

13. The device according to claim 1, characterized in that the container (4) is insulated.

14. The device according to claim 1, further comprising a display device (8) that displays the milk temperature sensed by the temperature sensing device (5).

15. The device according to claim 1, characterized in that a fill level in the container (4) can be sensed by the at least one infrared sensor (6, 6′).

16. A coffee machine (3) comprising a device (1) according to claim 1, characterized in that the temperature sensing device is connected to communicate with a control device (9) of the coffee machine (3) and transmits signals to the control device (9), for controlling a beverage dispensing process.
